(19) United States
(12) Patent Application Publication
(10) Pub. No.: US 2004/0068552 A1
(43) Pub. Date: Apr. 8, 2004

(54) Methods and apparatus for personalized content presentation

(76) Inventors: David Kotz, Lyme, NH (US); Daniela Rus, Hanover, NH (US); David Marmaros, Austin, TX (US); John C. Artz, Newton, MA (US)

Correspondence Address: David Kotz, 137 River Road, Lyme, NH, 03768, US

(21) Appl. No.: 10/250,449

(22) PCT Filed: Dec. 26, 2001
(86) PCT No.: PCT/US01/49518

(51) Int. Cl. G06F 15/16

(52) U.S. Cl. 709/218; 709/203

(57) ABSTRACT

Methods and structure for dynamically tailoring selection of rich content for recommendation to a user wherein the recommendation process determines recommendations in accordance with past user selections. A server process (102) provides lists of recommended content to a client process (100), through a WAN (104), associated with an identified user. The user on the client process (100) then selects content and provides the server process (102) with a rating through the user feedback input (112).

### RELATED APPLICATIONS

This patent is related to, and claims priority to, co-pending U.S. Provisional Patent Application Serial No. 60/258,301, filed Dec. 26, 2000 and hereby incorporated herein by reference. This patent also relates to research by co-inventor John C. Artz published on Jun. 9, 2000 as Dartmouth College Computer Science Technical Report PCS-TR2000-372, entitled “Personal Radio”, hereby incorporated herein by reference and available online at: “http://www.cs.dartmouth.edu/reports/abstracts(TR2000-372/.”

### BACKGROUND OF THE INVENTION

1. Field of the Invention

The present invention relates to multimedia content selection and delivery from a server process to a client process and in particular relates to a system for multimedia content recommendation, selection and delivery in accordance with selection criteria based, in part, on user preferences, on past user selections, on user location, and on other factors.

2. Discussion of Related Art

The distribution of information from a provider to a consumer through computing telecommunications networks is part of a rapidly growing industry. Information content that contains a variety of formats such as audio, video, graphics, text, etc. is often referred to as rich content or multimedia content. One common example of rich content delivery systems is use of the Internet and, in particular, present-day use of the World Wide Web on the Internet. Present-day use of the World Wide Web generally involves a person using a Web browser client process to request delivery of identified content from an identified server process or server node via the Internet. Under this paradigm, a user browses the Web looking for information relevant to the user's present interests and requests transmission and presentation of such located information. Search engine sites on the Web may aid the user in locating relevant information but none-the-less, the user still must locate and request the information to be presented. The server node then responds to the user's request by transmitting the requested content for presentation by the user's Web browser.

Other features of the Internet permit use of so-called “push” technology whereby a vendor or other provider of information sends generally unsolicited information through the Internet for presentation to the user at a Web browser client process or using other presentation processes. For example, push technology is often utilized to transmit advertisements from a vendor to a Web user regardless of whether the user has requested such information.

Though push technology has generally been utilized for providing advertising content to a user on the Web, present utilization of computing networks does not provide for analysis of preferences of the user or other factors to push other forms of content to the user that may be most useful or desirable for the user. For example, it would be desirable to provid recommendations of audio or video content to a user based on monitoring of past user selections, expressed user preferences and implications or inferences drawn from similarity between a particular user and other users in their preferences for particular forms of audio or video content. In particular, present techniques do not provide for dynamically adapting the selection and recommendation of particular content for a particular user in accordance with dynamic preferences and selections by the user including both implicit and explicit preferences.

Further, present techniques encounter serious limitations when applied to wireless computing communication networks that, at present, have little limited bandwidth and connectivity. Since the bandwidth available in such devices is limited and the connectivity is often sporadic, optimizing use of the available connection and bandwidth would suggest pushing content to the user that is most likely to be useful to that particular user. Furthermore, by pushing content to the user in anticipation of the user's future needs, whenever bandwidth is available, the user may use the content even when disconnected from the network or only weakly connected (i.e., with intermittent connectivity or low bandwidth available).

It is evident from the above discussion that a need exists for improvement in application of push technologies to provide recommendations of content to a user in accordance with dynamically changing user preferences as well as dynamically changing user location.

### SUMMARY OF THE INVENTION

The present invention solves the above and other problems, thereby advancing the state of the useful arts, by providing methods and associated structure for dynamically tailoring recommendation, selection, and delivery of multimedia content to a user through push techniques in accordance with user preferences, past user selections and user location. In particular, the present invention provides for a client/server architecture wherein a client process is provided with recommendations for rich content to be selected by a user. Further, the user provides feedback information consisting of ratings as well as selection versus non-selection of particular recommended content. This feedback information is returned to the server process and utilized to dynamically adjust preferences associated with the user. Further, the invention provides for characterizing content so as to enable matching of the user's preferences with available content. These preferences and content characterizations, along with myriad other factors, are used to select further lists of recommended rich content. This personalization of content selection and delivery provides improved matching of content delivery with measured user preferences and attributes. This, in turn, enables improved utilization of limited bandwidth and connectivity where mobile devices are used for presentation of content to the user by improving the utility of content for the user.

Still more specifically, a client process receives ordered lists of identified, recommended content from a server process. The client process allows the user to select from recommended content and presents the selected content to the user. For example, the recommended content may include a variety of audio recordings selected by the server as likely to be of interest or utility to the identified user. Selections made by the user are returned to the server process to permit the server to download the requested content if necessary. Further, the user's selections of recommended content (and hence non-selection of recommended content) are used in the server process to update user preferences for factoring into subsequent recommendation processing. Still further, selected content may be rated by the user such that the rating information is also returned to the server process to be utilized in subsequent recommendation computations.

From a server perspective, the present invention provides for computing a vector model similarity graph incorporating multidimensional data to evaluate similarities between user attributes and pref rences and available content as well as similarities between a particular user's preferences and attributes and other similar users to identify content selected by other us rs with similar preferences and interests. Weighted cosine vector computations, as known in the art, are utilized to determine recommendations for content likely to be useful or interesting to the identified user from the vector model similarity graph.

A first aspect of the invention therefore provided a system for content delivery comprising: a communication medium; a client component coupled to the communication medium for presenting received content to a user. The client component preferably includes a selection component for permitting a user of the client component to select received content to be presented; and a feedback component to communicate the selections to a server component; and a server component coupled to the communication medium for delivering content to the client component, The server component preferably includes a personalization component for recommending content for delivery to an identified user of the client component in response to information received from the feedback component.

Another aspect provides that the client component preferably further includes a cache memory for storing the received content for later selection and presentation.

Yet another aspect provides that the client component further includes a global positioning system component to identify a present location of the client component. The selection component preferably includes a location selection component for selecting from the received content based upon the present location of the client component.

Still another aspect provides that the client component is preferably a Web browser and the feedback component preferably communicates with the server component via the communication medium using Hypertext Transfer Protocols.

Still yet another aspect provides that the client component is operable within a portable computing device.

A further aspect provides that the communication medium is a wireless communication medium.

Yet a further aspect provides that the received content comprises identification information for recommended content.

Still a further aspect provides that the selection component selects recommended content based upon the identification information and requests delivery of the selected recommended content from the server component.

Still another aspect provides that the server component preferably further includes a user authentication component for authenticating the identity of a user of the client component

Yet another aspect provides that the personalization component preferably includes a utility estimation component for estimating the utility of available content. The utility estimation component preferably includes utility estimation based upon the information received from the feedback component; and a selector component to select recommended content for the identified user based on the estimated utility of the available content

Still another aspect provides that the utility estimation component preferably includes a similarity graph computation component for determining a similarity graph representing utility of content as a multi-dimensional vector space model.

Still yet another aspect provides that the selector component preferably includes a similarity selector that selects content based on a cosine metric of vectors in the vector space model.

A second aspect of the present invention provides a method operable in a server process for content selection and delivery to a client process comprising the steps of: selecting recommended content for an identified user of the client process based upon utility information represented as a multi-dimensional similarity graph vector space model; communicating the recommended content to the client process for selection by the user; receiving feedback information from the client process regarding the user's selection of content from the recommended content; and updating the utility information based on the feedback information.

Another aspect of the method provides that the utility information includes location information. The feedback information preferably includes the location information corresponding to the identified user.

Still another aspect of the method provides the step of sending the selected content to the client process in response to receipt of the feedback information.

Yet another aspect of the methods provides that the step of selecting includes the steps of: computing a user similarity value to identify content selected by similar user to the identified user, and computing a content similarity value to identify content similar to preferences of the identified user.

Still yet another aspect of the method provides that the step of selecting preferably further includes the step of combining the user similarity value and the content similarity value to identify content to be recommended to the identified user.

A further aspect of the method preferably provides the step of caching the recommended content in a memory associated with the client process for later presentation to the user of the client process.

### BRIEF DESCRIPTION OF THE DRAWINGS

FIG. 1 is a block diagram of an embodiment of the present invention in which a client and server process exchange information for recommending rich content to be presented to a user of the client process.

FIG. 2 is a combined flowchart and data flow diagram describing operation of the client and server processes of FIG. 1.

FIG. 3 is a graph depicting exemplary attributes of a user and a content item to describe matching of an item with a user's attributes.

FIGS. 4 and 5 are exemplary screen dumps of typical computer graphical user interfaces for interaction between the user and the client process.

FIG. 6 is a flowchart providing additional details of the processing in FIG. 2 to select recommended content by the server process.

FIG. 7 is a flowchart providing additional details of the processing in FIG. 2 for an improved method to s lect recommended content by the server process.

### DETAILED DESCRIPTION OF THE PREFERRED EMBODIMENTS

While th invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents, and alternatives falling within the spirit and scope of the invention as defined by the appended claims.

As noted above the present invention comprises cooperating client and server processes. In general, the client process provides user identification information to the server process so that the server process may identify recommended content based on the identity of the user. Recommended content is then returned from the server process to the client process to permit the user to select from the recommended content list. The user's selection of content from the recommended content list is communicated to the server process and the requested, selected content is returned from the server process to the client process. The user's selection from the recommended list constitutes a form of feedback to the server process informing the server process that the user has expressed a preference for the selected content over other content in the recommended list that was not selected. In addition to the user's selection of content from the recommended list, feedback information provided by the user regarding the desirability and utility (i.e., a rating) of the presented content may be returned to the server process. All information so returned from the client process to the server process may be used by the server process to update its model for further, future recommendations of content to this or other users.

In accordance with the present convention, a client process (also referred to herein simply as “client”) may be any of several devices capable of providing the client functionality. For example, the client process may be operable within a portable, personal digital device such as a Palm™ device or Pocket PC™ device preferably integrated with telephony functions or other wireless communications capabilities. Further, the client process may be operable within an Auto-PC (i.e., a device permanently located in the user is automobile or other vehicle having only sporadic access to the server process through wireless communications techniques). In both such cases of a portable or movable client, sporadic connectivity and lower data bandwidths presently available through wireless communications techniques pose particular problems for rich content delivery.

Those problems exacerbated by mobile devices are addressed by the present invention, in part, by improving the utility of information pushed to the client process from the server. The limited bandwidth and connectivity of such portable devices is therefore better utilized by providing more desirable and more useful content to the user. Also as noted above, the present invention is operable to push content likely to be of interest to the user in advance of the user's need for such content. The content may therefore be pushed during periods of available bandwidth for playing by the user at a later time (i.e., during periods of weak connectivity or limited bandwidth connectivity). Further, a client process may be operable within a standard desktop personal computer in a relatively stationary position with an essentially permanent, high-speed network connection to the server process.

In addition, the client process preferably communicates with th server process utilizing standard communications protocols of the Internet including, TCP/IP, HTTP, and FTP protocols. Those skilled in th art will readily recognize that a variety of communication protocols and media may be applied to the client/server architecture provided by the present convention. The Internet and its associated standard protocols are merely one exemplary preferred embodiment of such a network communication protocol and medium.

Still further, a feature of the client process is its capability to present rich content to the user. Such content presentation includes the ability to “play” downloaded multimedia presentation content including, for example, audio and video content (whether stored locally or streamed from the server). Such multimedia presentations are preferably provided through numerous devices and environments. Custom stand-alone program interfaces for the user may provide the multimedia presentation on any device. Standard graphical user interfaces (“GUIs”) known on the Internet such as Web browsers including Netscape™ and Microsoft Internet Explorer™ may preferably provide the requisite multimedia presentation. Other standard user interfaces common to handheld, portable digital devices may also provide such presentation features.

A minimum requirement for any client is therefore a capability for playing or presenting rich content such as audio and/or video data, capability for communicating with the server process via a communication medium and protocol (such as the Internet), and a capability for downloading content to be played immediately or to be stored in a local cache for later selection and playing. Further optional features of the client in accordance with the present convention include a capability for providing rating feedback information to the server process in addition to simple selection information. Selection information plus any optional feedback information provided from the client process to the server process is utilized in the server process as discussed further herein below to update the mathematical model used for personalization and recommendation of content to a particular user. Another optional feature provides a global positioning system (“GPS”) element integrated with the client process for providing present location information to the server process regarding the particular user of the client process.

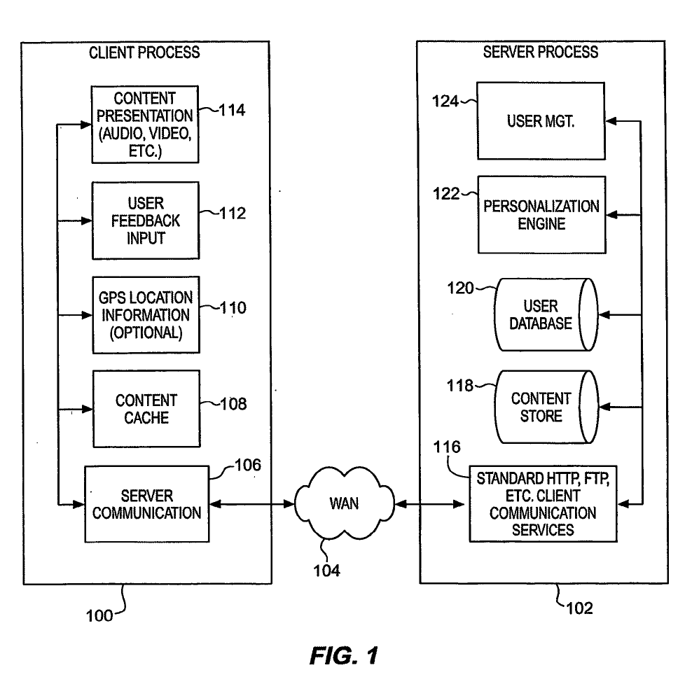

FIG. 1 is a block diagram of functional elements of the client and server processes of the present convention. Client process 100 communicates with server process 102 through network connection 104. As noted above, in an exemplary preferred embodiment, the Internet is used as a communication medium and protocol coupling client process 100 to server process 102. Those skilled in the art will recognize a variety of network communication protocols and media for communications between client process 100 and server process 102. For example, the two processes may even be co-resident within a single computing device and utilize well-known interprocess communications techniques within a single computing node. Server communication element 106 within server client process 100 and client communication element 116 within server process 102 coordinate the bidirectional communications between the two processes.

As noted above, client process 100 has a content presentation element 114 for presentation of received content selected by the user such as audio content, video content and other multimedia forms of content. Through server communication element 106 of client process 100, client process 100 preferably establishes a streamed communication connection to the server process for rapid, real time receipt and presentation of selected rich content through content presentation element 114. Content cache 108 is a memory element capable of caching received content for later presentation. Such a cache memory element is most desirable where client process 100 is operable in a portable wireless digital device so that content may be received and stored when the portable device has appropriate connectivity with server process 102.

Client process 100 also preferably includes user feedback input element 112 to permit the user to provide editorial feedback to server process 102 regarding recommended content selected by the user for presentation. User feedback input element 112 utilizes any of several well-known user input means such as a mouse, any other pointer device, touch screen capabilities, keyboards, voice recognition, etc. User feedback received from such input means is returned to the server process to update its user database information regarding preferences and attributes of the particular user of the client process 100.

Optionally, client process 100 may include GPS location information as part of the feedback information provided to server process 102. Such location information permits server process 102 to refine its recommendations for useful content based on the present location of the user of the client process 100. Those skilled in the art will recognize other similar forms of location information that may be provided by the user such as zip code, phone number, address, etc. GPS specific information may be most valuable in portable devices operating client process 100 due to be dynamic nature of locating such a portable digital device.

Server process 102 includes user management element 124 to maintain database information regarding identified user selections, preferences, attributes, location, etc. Such user information is preferably maintained within user database 120 of server process 102. Those skilled in the art will recognize a variety of indexing techniques and data storage management structures for maintaining such user information. Exemplary of one such management system is a relational database or an object-oriented database management system to record user information in a manner that is structured, indexed and therefore easily retrieved.

Content store 118 provides mass storage capabilities for storing large volumes of rich content. Though not a requirement, an exemplary preferred embodiment includes attribute information (also referred to herein as meta-data) characterizing each element of content stored in content store 118. As above, those skilled in the art will recognize a variety of storage management subsystems for indexing and storing information regarding each element of content for rapid retrieval and broad characterization. Though preferred, the present convention does not require characterization information to be associated with each element of content stored in content store 118. Rather, the present convention is capable of relying exclusively on user selection and preference information to identify content likely to be of interest or useful to a particular user. Further, as described in more detail herein below, comparison of an identified user to other user's preferences, selections, and attributes of other users similarly situated to a particular identified user may also be utilized for selecting content for a particular identified user. In other words, the present invention may fully “characterize” content simply by reference to users that have selected and rated the content with no knowledge of the content or related meta-data.

The present invention has a personalization engine 122 that utilizes user attribute information and content characterization information (if any) to select recommended content likely to be of interest or utility to a particular identified user. Details of methods and structures associated with elements 118 through 124 are provided herein below.

As noted, element 116 within server process 102 provides client communication services for communication between client process 100 and server process 102. Furthermore, element 116 preferably provides standard HTTP, FTP and other Web related communication services common to most Web server devices and processes.

Those skilled in the art will recognize that the processes and functional elements depicted in FIG. 1 are intended merely as representative of one exemplary architecture for providing features and benefits of the present invention. Numerous equivalent configurations and architectures may provide similar features. Such architectural design choices are well-known to those of ordinary skill in the art.

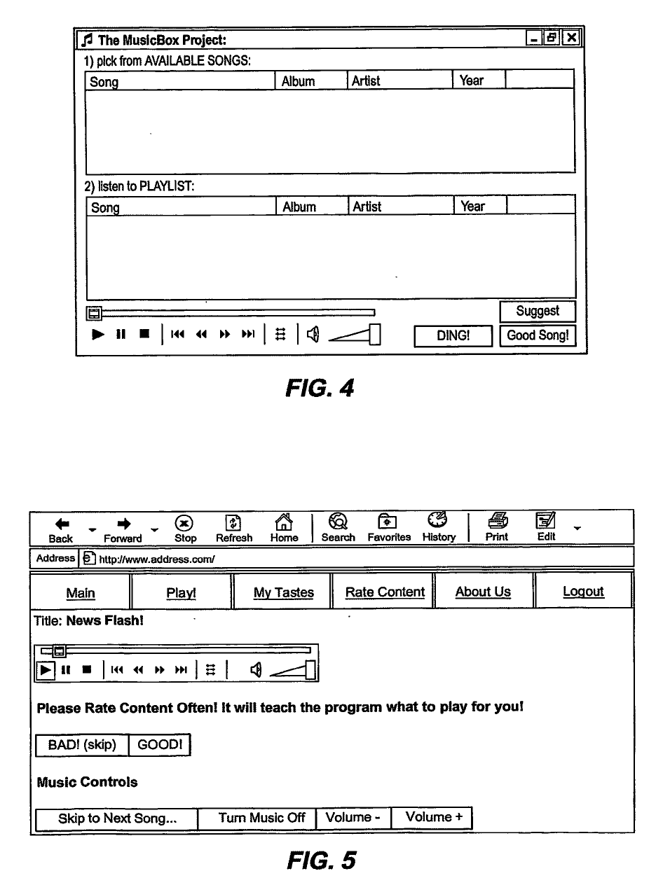

As noted, client process 100 may be operable in any of a number of devices for presenting content to a user and for receiving user input for selection of recommended content and for providing feedback of content presented to the user. FIGS. 4 and 5 are exemplary screen images of typical user interfaces useful for client process user interaction in accordance with the present invention. In particular, FIG. 4 is an exemplary standalone, custom user interface program for listing suggested (recommended) audio content in response to a user “clicking” the “Suggest” button of the interface. A user may rate the received content (the played audio content) by clicking the “Good Song!” button of the interface. FIG. 5 is another exemplary screen image of a similar user interface provided through the interface of a standard Web browser client process-specifically, for example, Microsoft Internet Explorer. Ratings are provided through a user clicking the “Bad!(skip)” and “GOOD!” user interface buttons as well as sampling recommended selections through clicking of the “Skip to Next Song . . . ” user interface button.

Those skilled in the art will recognize a wide variety of equivalent user interface designs and techniques for presenting recommended content to a user and for receiving user selections and additional feedback. For example, such designs may include both graphical/iconic and textual computer “buttons”, voice command systems, and physical switches or buttons such as a computer keypad or an automobile device such as an enhanced “radio.” FIGS. 4 and 5 are therefore intended merely as suggestive of some exemplary interface techniques used in conjunction with the present invention to receive such user input. Myriad other design choices will be readily apparent to those of ordinary skill in the art.

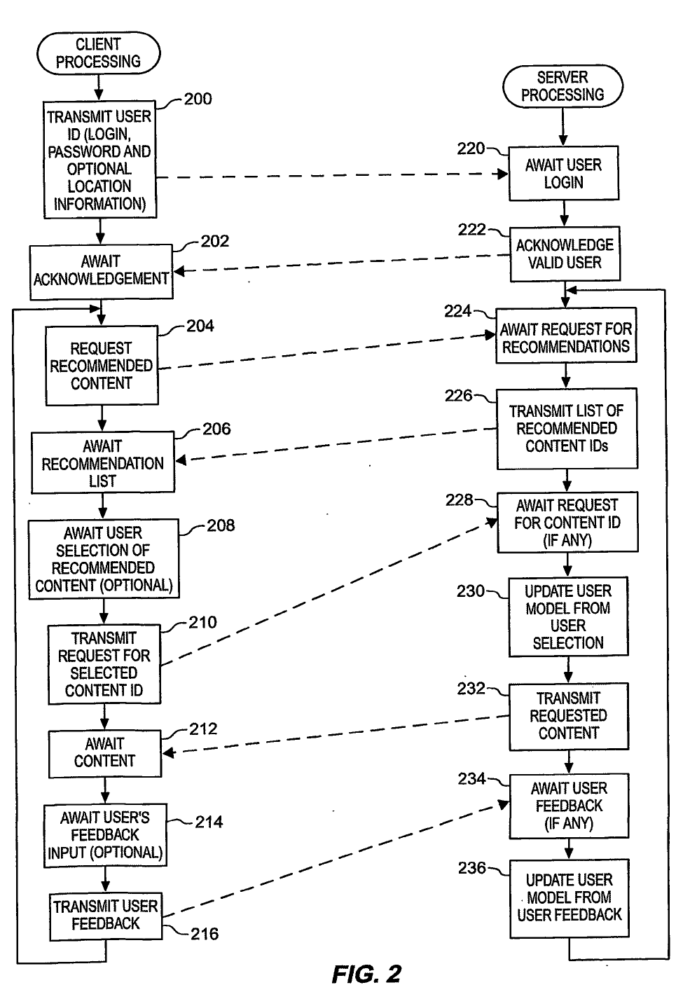

FIG. 2 is a combined flowchart and data flow diagram describing operation of, and communications between, client process 100 and server process 102 both of FIG. 1. The directed, dashed arrows between elements of the flowchart indicate corresponding data flow between the client process and server process. Elements 200 through 216 describe operation of client process 100 and elements 220 through 236 describe operation of server process 102.

Element 200 is first operable to transmit user identification information such as a login ID and password and optionally location information such as GPS location or other indicia of present user location. The dashed arrow out of element 200 indicates the transmission of such user identification information. Those of ordinary skill in the art will recognize a variety of equivalent login procedures to provide user identification and/or location information. Further, those of ordinary skill in the art will recognize that other data encryption and security mechanisms may be added as layers atop the exchange of such login information to secure any sensitive information in the login process.

Element 202 then awaits receipt of acknowledgment from the server process indicating authentication of the identified user and readiness of the server process for continued communications. The dashed arrow into element 202 indicates receipt of such an acknowledgment. Elements 204 through 216 ar then iteratively operable to request lists of recommended content from the server, to permit the user to select from the recommended content, to receive selected content and present the received content to user.

Specifically, element 204 transmits to the server process a request for an updated recommended content. The dashed arrow outbound from element 204 represents such a transmitted request for recommended content. Element 206 then awaits receipt of an ordered list from the server representing present recommended content. Preferably, the list is ordered by likely utility or interest to the identified user. The inbound dashed arrow to element 206 represents receipt of such an updated recommendation list. Element 208 then awaits the user's selection of an element of content from the list of recommended content. As noted above such input may be obtained from any of several well-known user input devices including, for example, mouse, keyboards, touch screen, other pointer device, voice recognition, etc. After the user selects a particular element of content from a recommendation list, element 210 then transmits a request to the server process to transmit the selected content. A content HI) tag is preferably included in the request to identify the particular selected content from the recommended list. The dashed arrow out of element 210 indicates such a transmission requesting selected content Element 212 then awaits receipt of the selected content transmitted by the server process. The dashed arrow into element 212 represents receipt of the transmission of the requested content.

Those skilled in the art will recognize that the processing of step 208 to await receipt of a user selection from the recommended content list is an optional step. In an alternative exemplary preferred embodiment, the client process may simply present the content from the recommended list in the order recommended by the server process. The user then “de-selects” a particular content item by requesting that the client process skip that content item and proceed to the next content item on the recommended content list. Such “de-selection” is an analogous first form of feedback to the server process in that the client process preferably reports back to the server process that a particular content item was skipped by the user.

Further, those skilled in the art will recognize that the processing of elements 208-212 to select, request and receive a content item may also be implemented as a selection, request and receipt of multiple items. In other words, the user at the client process may select at element 208 multiple content items from the recommended list. Element 210 then requests the download of such multiple selected content items and element 212 receives the multiple selected content items.

The selection (or de-selection) of a particular element of content is a first form of feedback provided by the client process to the server process. This feedback enables the server process to update its user management and content management databases indicating the user's preference for the particular selected element of content. As noted above, the present invention optionally includes additional user feedback elements providing, for example, a rating of the particular selected content. As the selected content received from the server process is presented to the user, element 214 optionally awaits user feedback input from any of several well-known user input devices as noted above. This additional user feedback information preferably includes the user's rating of level of interest or utility of the content presented. Following receipt of such user feedback, element 216 transmits the user feedback (if any) to the server process to permit further updating of its user preferences and attributes reflecting the users comments on the selected, presented content. The dashed arrow out of element 216 represents the transmission of such user feedback information. Processing of the client then continues by looping back to element 204 to request an updated list of recommended content from the server process.

As regards the server process, element 220 is first operable to await user ID and other login information transmitted from the client process identifying the particular user and optionally the users present location (i.e., GPS information, zip code, phone number, etc.). The dashed arrow into element 220 indicates receipt of such user identification and location information. Element 222 then validates the user information and, if valid, transmits an acknowledgment to the client process indicating the validity of the user ID and readiness for further interaction. The dashed arrow out of element 222 represents the transmission of such an acknowledgment.

Elements 224 through 236 are then iteratively operable to exchange information with a client process including recommendation lists, requests for particular selected content from the client, and transmissions of the selected content for presentation by the client process. Specifically, element 224 awaits receipt of a request from the client process requesting an updated list of recommended content. The dashed arrow into element 224 represents receipt of such a request from the client process. Element 226 then transmits a current list of recommended content IDs likely to be useful or interesting to the identified user. The personalization engine discussed further herein below determines which content is likely to be useful or of interest to the identified user. The dashed arrow out of element 226 represents such a transmission of a recommendation list. Element 228 then awaits receipt of a request from the client process for a particular content element from the recommended list identified by a content ID. As discussed above, the user selects an element of content from the provided recommendation list and requests transmission of the selected content. The dashed arrow into element 228 represents receipt of such a request for particular selected content identified by content ID information

Element 230 then updates user model information from the particular selection made by the user. As noted above, one element of feedback information provided by the user is the selection (and therefore also non-selection) of particular content from the recommendation list. User preferences and attributes are updated by the user management feature of the server process to indicate a preference by this user for the particular selected content. As above, details of the personalization engine regarding update of user and content attribute information are provided further herein below. Element 232 is then operable to transmit the requested content back to the client process for presentation to the user. As noted above, the requested content is preferably returned to the client process utilizing well-known Internet streaming protocols and techniques. Those skills in the art will readily recognize that any of a variety of equivalent communication media and protocols may be utilized to return potentially voluminous rich content information to the client process. The dashed arrow out of element 232 represents the transmission of requested content back to the client process.

Element 234 then awaits receipt of further user feedback information (if any). As noted above, such additional user feedback information may consist of ratings by the user indicating the degree of interest or utility by the user in th particular selected content. As above, d tails of operation of the personalization engine to update user preferences and attributes based on such additional user feedback information are provided further herein below. The dashed arrow into element 234 represents receipt of such additional user feedback information (if any). Feedback information as used herein can also refer to numerous other points of information. For example, the feedback information may include the exact time or location of presentation of the content item to the user. Particular content items may therefore develop an affinity for presentation at particular times of day or in particular locations. These other forms of feedback information may also be incorporated into the methods and structure of the present invention as attributes of content items and of user preferences.

Element 236 then updates the user information based on the additional user feedback information (if any). Again, details of the personalization engine for generating and updating such attribute information is provided further herein below. Processing then continues by looping back to element 234 to await receipt of further requests for updated recommendation lists.

Those skilled in the art will recognize that client/server interactions as described above with respect to FIG. 2 need not proceed in such “lock-step” fashion. In particular, where connectivity is intermittent or available bandwidth is limited, the client/server interactions may proceed in batches or may simply not require input from the cooperating process. For example, lists of recommended content may be provided to the client without awaiting a client request for such. The lists may then be saved and available within the client process for later review and selection by the user. Or, for example, the processes may not await user selection from the recommended list but may simply start presentation of the recommended content in the order provided by the server process. The user of the client process may then indicate “selection” or “deselection” of the present recommended content by skipping the present content item and proceeding to the next recommended content item. Therefore, the interactions discussed above with respect to FIG. 2 do not require that the client and server processes interact in the presented lock-step method. Those skilled in the art will readily recognize that the flowcharts and data flow diagram represented in FIG. 2 are intended merely as representative of one exemplary preferred embodiment of the present invention. Numerous other techniques and structures may be utilized to exchange information between the client and server process, to identify potentially interesting content for the user, to request presentation of a particular element of content, to transmit requested content and to receive user feedback information regarding the degree of interest or utility in the information for that identified user.

### Personalization Engine

The personalization engine (also referred to here as “Personalization Algorithm” or “PA”) determines content likely to be of interest to an identified user. Broadly defined, a Personalization Algorithm uses available information (1) to choose a subset (2) of the content in a specific order (3) within time and space constraints (4) to optimize utility (5). It is assumed that the PA has available all of the information that the current user as well as all other users has provided to it. These consist of both past recommendations to the users, their feedback (selections and ratings feedback), existing or derived metadata describing the content, and metadata describing the users.

The output of such an algorithm is defined as an ordered subset of the content corpus. As discussed, the present invention is applicable to many forms of multimedia presentations including audio content, video content, etc. The discussion to follow focuses primarily on audio content as an exemplary form of content to be distributed in accordance with the present invention. For example, the discussion to follow speaks in terms of “playing” or “listening” to the selected content. The term “playing” or “listening” should be understood as synonymous with the broader term of “presenting” content though clearly audio content would normally be referred to as being “played” or “listened to.” Those skilled in the art will recognize that the invention is broadly applicable to many forms of multimedia content. Reference to audio content or the playing of content is therefore not intended as a limitation on the scope or applicability of the present invention.

The content may provide different utility if played in a certain order. For example, the user may derive utility from listened to content which is similar in genre, or possibly with alternating genres. (See prior research by M. Alghoniemy and A. H. Tewtik, “Personalized Music Distribution.” ICASSP'00 Proceedings: 2000 IEEE International Conference on Acoustics, Speech, and Signal Processing, 2000, pp 2433-2436). There may also be an advantage to playing content at a certain time. The order of play dictates the exact time at which the client presents a content item to the user, and so it is significant. Finally, it may be desirable to provide “instant gratification” to the user to improve their initial impression of the system and improve retention. Thus is may be beneficial to present the content item with the highest estimated utility first. As such, an algorithm can have different priorities when determining an ordering.

Constraints may limit the type, size, or length of content that may be recommended. For example, the client device may have a fixed cache size that can only hold 10 megabytes of data Alternately, the data may have an associated cost, for example, if the user has to pay 10 cents per content item and she has limited her spending 22 dollars per day, the utility per unit price metric must be optimized and its constraint followed.

Utility is defined herein as “the amount of benefit that the user receives from the recommended content.” It is an extremely difficult and hard to quantify problem to perfectly assess utility for a human. As such, an estimation function is the best that the system can do to predict how much utility a content item will provide for the end user. Those skilled in the art will recognize alternative definitions of utility that may be measured and hence applied in conjunction with the methods and structure of the present invention. Currently the algorithms of the present invention optimize the utility to the user—i.e., the consumer of the presented content. It is equally possible under an alternate embodiment to optimize the utility of other parties related to the system. For example, the creator or producer of the content, who will perhaps be selling each item at a specific cost, would optimize her utility by a maximum profit. It is similarly possible to jointly optimize the sum of the users' utilities. While this is feasible, the invention may commence by focusing solely on optimizing the one user's utility.

Consider the algorithmic implications. As defined above, the PA problem is NP-Complete. In fact, the well-known “0-1 Knapsack” problem reduces to the PA techniques presented herein (see for example, Grey, et al., Computers and Intractability: A Guide to the Theory of NP-Completeness, W. H. Freeman, 1979). Since the academic community considers this category of algorithm to be intractable using present computing methodologies, it is preferred that definition be pared down or approximation functions must be used.

The present invention provides two related methods of personalization to simplify the computability of the problem. First, the set of content items is stochastically filtered. This has several implications. The most important is that a smaller input set is generated which can reduce an intractable problem to a problem that can be computed in real-time. The implication of this operation on the quality of the algorithm is minimal, as is shown herein below.

The second option for simplifying the PA is to fill the recommendation list with items using a greedy algorithm instead of the optional “0-1 Knapsack” methodology. While this step would reduce the running time to a computable level, it may influence quality. Note, however, the scope of the possible constraints imposed by the client device is limited, a greedy algorithm may still yield an optimal solution. If the only constraint is the number of content items that could be given to the client, then the greedy algorithm would function optimally. On many streaming clients, this is the only constraint imposed, and thus it is worthy of consideration. Element 226 of FIG. 2 represents the processing to transmit a recommendation list to the requesting client process for an identified user. Inherent in this process is the process to create the recommendation list. Hence, the PA (personalization engine) is operable as part of the processing of element 226 of FIG. 2.

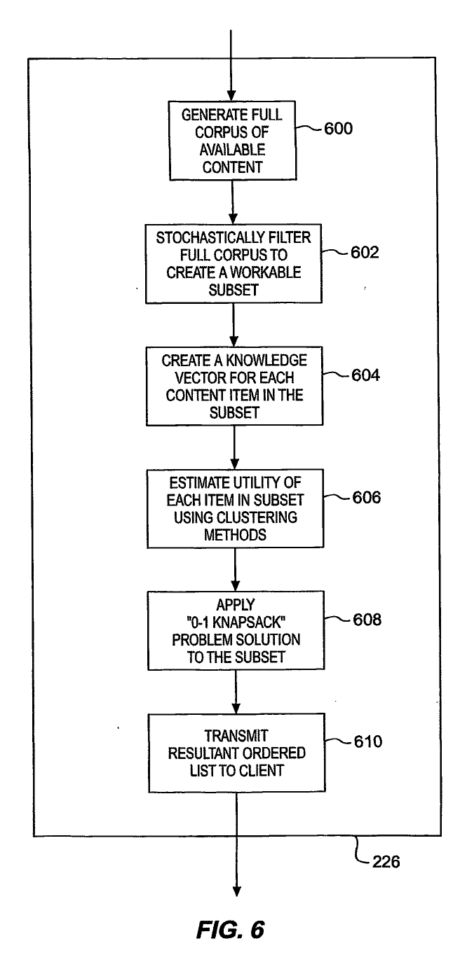

FIG. 6 is a flowchart providing additional details of a first exemplary, preferred embodiment of the personalization engine of the present invention. Element 600 represents processing to gather the entire corpus of content items known to the system. Such information is preferably stored in a content store (i.e., database management system) as noted above with respect to FIG. 1. Element 602 then applies well-known stochastic filtering to the full corpus to reduce the number of potentially relevant items to a workable subset. As noted above, this step may impact quality of the personalization engine but not dramatically so. Element 604 then generates a knowledge vector for each content item in the reduced subset of content. Details of this function are discussed further herein below. Element 606 then estimates the utility to the identified user of each content item in the reduced subset applying known clustering methods to the reduced subset. Details of this element are discussed further herein below. Element 608 then applies known solution techniques to solve the “0-1 Knapsack” problem as represented by the reduced subset of content items generated by the above elements of FIG. 6. As noted, application of these known techniques to the reduced subset of content items is a computable problem. Further details of the element operation are provided herein below. The order list of content items generated by the above processing is then transmitted to the requesting client process.

### Utility Estimation

The Utility Estimation feature of the present invention (element 606 above) is based on prior work on Clustering Algorithms in the field of information retrieval. (See Javed Aslam, Katya Pelekhov, Daniela Rus. “A Practical Algorithm for Static and Dynamic Information Organization.” In Proceedings of the 1999 Symposium on Discrete Algorithms, Baltimore, MD). In particular, the present invention applies these prior techniques in filtering. (See Javed Aslam, Katya Pelekhov, Daniela Rus. “Using Star Clusters in Filtering”, Proceedings of the 2000 International Conference on Information Knowledge Management, CIKM 2000). The core to th Utility Estimation process is based on an offline clustering algorithm.

Building on the definition of a PA, th methods of the present invention may represent all of the available information within the system in a manner that allows convenient estimation of utility. Using Clustering intuition as a guide, data is formulated into a similarity graph, which is defined as an undirected, weighted graph G=(V,E,w) where V is a set of vertices, E is a set of edges connecting vertices, and w is a set of weights, one for each edge. Each content item is represented by one vertex of the graph G. Furthermore, one vertex is added to the graph G for each user. Each edge weight corresponds to the similarity between the two items at the ends of the corresponding edge. Similarity between two documents is measured by using a metric that is standard within the Information Retrieval field. The cosine metric in the vector space model of the Smart information retrieval system has been used extensively. (See G. Salton, “Automatic Text Processing: The Transformation, Analysis and Retrieval of Information by Computer”, Addison-Wesley, 1989). (See also G. Salton, “The Smart Document Retrieval Project”, Proceedings of the 14th Annual ACM/SIGIR Conference on Research and Development in Information Retrieval, pp. 356-358, 1991).

The vector space model within the Utility Estimation function of the present invention preferably contains seven different categories of dimensions. Each of these represents a type of data used to estimate utility. There is no fundamental difference between these categories, and they are all formulated such that the cosine metric will function without modification. These divisions are used to emphasize the different sources of the data, since user and content vertices are filled using different mechanisms.

The seven categories of dimensions are preferably as follows:

| Category | Content Data | User Data |
|---|---|---|
| 1) Content Ratings. n | Content j receives a 1 in | 0 for all unrated content. The |
| dimensions are allocated for | dimension j, and a 0 in all | rating, positive or negative, for |
| content, where n equals the | other content dimensions | each rated content. |
| number of content items. | | |
| 2) Temporal Rating. 24 | 0 if no applicable temporal | Set the current time and date with |
| dimensions for hours. 365 | rating. Above zero if it is | a rating of 1. Create a bell curve |
| dimensions for days. Or as many | tuned for a specific time or | ahead and behind. |
| as applicable. | date. | |
| 3) Spatial Rating. 3 dimensions, | 0 if no applicable spatial | Set the dimensions equal to the |
| x-y-z. These are applied to | rating. Above zero if it is | current location. Create a bell |
| longitude, latitude, and altitude | tuned for a specific location. | curve within a radius around the |
| and aid in geographic relevance, | | location. |
| 4) Attribute Rating. m | 0 if the content does not | 0 if the user is neutral on that |
| dimensions are allocated for | possess that attribute. 1 if it | attribute. 5 if the user is in favor. |
| attributes, where m equals the | does. [or higher as | 50 if the user would like to listen |
| number of attributes, | applicable] | to this attribute exclusively. |
| 5) Frequency Rating. n | Content receives 0 if it does | Negative if the user has heard the |
| dimensions are allocated for | not diminish in frequency. | content j recently. Positive if the |
| content, where n equals the | Above 0 if it does. | user has not heard the content |
| number of content items. | | recently. |
| 6) Popularity Rating. 1 | Sum of all of the user vectors | 1 |
| dimension | assigned to the song in the | |
| | content rating | |
| 7) User Rating. w dimensions | Dimension k contains the | Dimension k contains Similarity |
| were w is equal to the number of | rating of this content by user | rating with user k as described in |
| users | k. | the User to User Comparison |
| | | section below |

The result of this representation is a high-dimensional vector space. Once formulated in this manner, the model can compare any user with any content item to determine the similarity between them. By construction, similar users and content items map to nearby vectors. In the vector space model, similarity equals the angle between the corresponding document vectors. The standard in the information retrieval community is to map the angles to the interval [0,1] by taking the cosine of the vector angles.

Those skilled in the art will recognize that values for any parameter or attribute can be scaled to cause the corresponding category to be more or less strongly weighted in the recommendation computations.

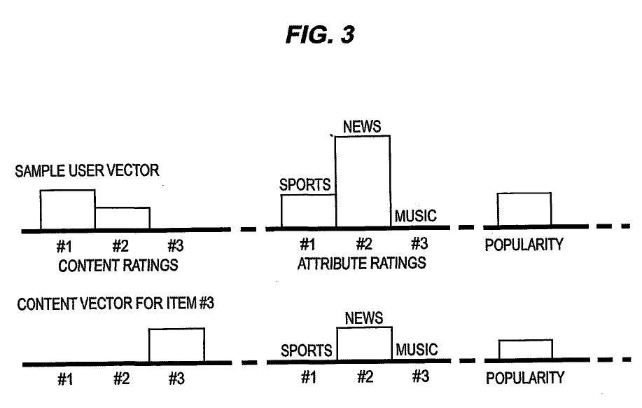

FIG. 3 graphically depicts sample dimensions within a User Vector and a Content Vector. The vectors in FIG. 3 depict the Content, Attribute, and Popularity Dimension. Specifically, FIG. 3 shows user vectors representing the user's ratings of 3 sample content items in different categories and shows the content vector for item 3 of the three sample items. In this particular instance, the user has not rated this content item before. The user has also exclusively requested News (as shown by the high bar in the News dimension). Since the sample content item is a news attribute, when these vectors are multiplied, they produce a high value that denotes similarity.

Given the nature of the algorithm, three applications of the similarity graph are presently feasible. User-to-User Comparison and User to Content Comparisons are vital in order to perform the operation. Content-to-Content comparison is of interest within the clustering field, but is not used within the context of this invention.

### User to User Comparison

This process is an intermediate step in formulating the user Information Vectors, specifically filing in the User Rating category of dimensions. The critical insight is that it can be determined which users possess similar tastes to the current user, and then factor in their content ratings accordingly to aid in formulating future recommendations. Only two categories differ in User-User comparisons: Attribute Rating and Content Rating. As such, vectors can be constructed for each user leaving all but these two dimensions at zero, or simply leaving out the extraneous dimensions. The cosine of the vector angles is then computed to determine the similarity between the users. The algorithm then places this result in the User Rating dimensions, and it aids in User to Content Comparison.

The justification for this critical insight stems from Dense Star-Shaped covers as presented by Aslam, Pelekov, and Rus (supra.).

The intuition of this result is as follows: assume that the similarity between person 1 and person 2 is 0.9. Furthermore, person 2 is known to have heard a content item and rated it highly. Person 1 has not heard this content item yet. However, it can be inferred that person 1 is likely to enjoy this content item.

Since users and content items are defined within the same vector space, they can be directly compared. The mathematically rigorous proof of this statement is as follows:

Consider three Information Vectors U₁, U₂, and C. U₁ and U₂ represent the two users described above, while C represents the content item. These entities are vertices of a star-shaped subgraph of graph G, which has a threshold of σ. Assuming that σ<0.9 and that the similarity between U₂ and C is greater than σ [lets say 0.7]. U₁ and C are satellite vertices and U₂ is the star center. The similarity coefficients are obtained in the vector space model by s calculating the cosine of the angle between the information vectors of each document.

Fact 1 Let Gσ be a similarity graph and let S1 and S2 be two satellites in the same cluster in Gσ. Then the similarity between S1 and S2 is at least:

s(α₁+α₂)=cos α₁ cos α₂−sin α₁ sin α₂ (equation 1)

Using the numbers stated above, it can be concluded that the similarity between User 1 and the content item is a minimum of:

(0.7)•(0.9)−\sqrt{1−(0.7)²}\sqrt{1−(0.9)²}≈0.32

While the above result does not imply a strong match, it mathematically proves that User 1 is likely to enjoy the content item C. Note further that this result is a worst-case scenario, and it is possible that a stronger match is present.

Having established that this intuition is mathematically grounded, it can be shown that it is computable within the vector model. Recall that the User Rating set of dimension was constructed so that the user vector contains the similarity between the current user and user j [cos α1], while the content vector contains the similarity between user j and the content item [cos α2]. Multiplying these two items in a vector multiplication yields the first term in the equation 1 above. It is next shown that this is sufficient to provide useful results.

cos(α₁+α₂)≈cos α₁ cos α₂ as cos α₁ approaches 1 (equation 2)

Since the construction of the user vector only includes the users that are similar, it is concluded that (cos α₁) approaches 1. If this is the case, then the second term will approach 0 regardless of the value of cos α₂. Thus, the remaining value is the first term, and this approximation is correct.

### User to Content Comparison

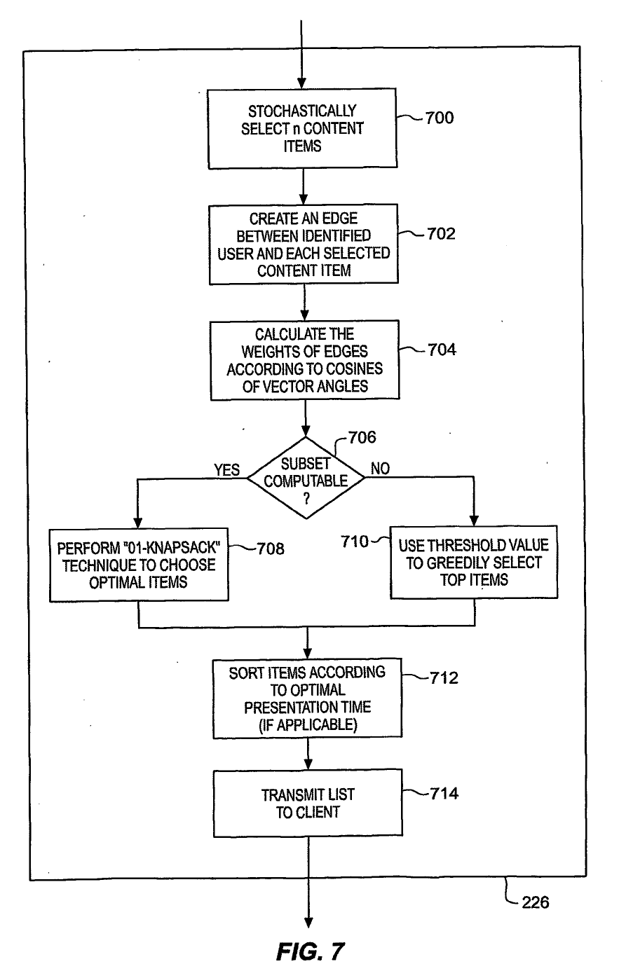

The previous section describes the process for constructing the vector for each user vertex within the similarity graph G. Next, the process of determining m recommendations in terms of a similarity graph is discussed. The method of FIG. 7 is an optimized version of the simpler method discussed above in FIG. 6. This method combines the options noted above to further improve the accuracy of the personalization process in recommending content to a user.

FIG. 7 is a flowchart of such a method for determining recommendations for a particular identified user (V₀) and hence further refining the details of element 226 for yet another embodiment. Element 700 is operable to stochastically select n content items from the full corpus of content known to the system. Specifically, n items V₁ through Vₙ are selected when n is greater than m (the number of recommendations to be ultimately selected by the method). This initial selection helps reduce the problem of content selection to a computable task. Element 702 then creates an edge for the graph G between the identified user node and each selected content as a node in the graph (i.e., an edge between (V₀ and Vᵢ where i is between 1 and n inclusive). Element 704 then computes the weights of thes edges according to the cosine of the respective vector angles. Element 706 then determines whether the constraints on the subset and the number of selected items (n) are appropriate to permit computation using the “0-1 Knapsack” methods. If so, element 708 applies the “0-1 Knapsack” methods to select the optimal m elements of the subset. If there are no constraints on the selected subset or if n is too large, a greedy technique is applied by element 710 to simply select the top m items in ordered by the computed weights. Those skilled in the art will recognize that the speed and storage capacity of the server system will affect the degree of problem that is “too large” to be practically computable. In accordance with present day server systems, millions of selected items (n) could be processed with acceptable response to the user. Clearly such capacity and responsiveness issues are resolved as well-known design choices in a particular implementation of the features of the present invention.

In any case, processing continues with element 712 to sort the m selections according to optimal presentation timing (if applicable). Element 714 then transmits the ordered list of recommended content so generated to the requesting client.

The recommendations are currently optimal within the stochastically selected sample set. Sampling reduces the running time of the algorithm. For example, assume k items are drawn for each item needed. Assuming that the similarity of documents to the user is distributed uniformly about the range [0,1]. The average quality of the resulting documents can be estimated. According to statistics, if k items are drawn from a uniformly distributed range of [0,1], then the expected maximum is (1-1/k). Assuming that (the Size of the corpus)>>(the number of documents sampled), then it can be assumed that each drawing is independent. Thus if k samples are drawn m times and take the maximum each time, then the average quality of the results will be E[1-1/k]. As k grows, the marginal benefit of this extra sampling shrinks asymptotically.

Within the model using stochastic sampling, a desired expected quality is stated. In the present invention, 90% is the stated expected quality as one exemplary preferred embodiment, which results in a k of 10. In comparison to using the full corpus, the running time of the algorithm is significantly reduced since a fixed constant is used as opposed to a variable input equal to the size of the corpus.

Stochastic filtering prevents an optimal outcome. This is a helpful feature. Without some randomness injected into the system, it is likely that the recommendations for a user would settle at a local maxima. The filtering allows the system to attempt slightly sub-optimal content items to check user feedback and change accordingly.

### Ordering Algorithms

There are numerous methods for choosing the ordering of the content. AIghoniemy and Tewtik (supra.) describe situations that allow the algorithmic optimization of content ordering in response to the users' preferences. The algorithm could perform this process at element 712 above to determine the proper order to place the items.

“Instant gratification” is achieved in this exemplary preferred embodiment by sorting the content in decreasing order of similarity number.

### Exclusive Categories

One preferable feature within this model is that the user be able to choose to listen to a particular category exclusively. For example, a busy person on the way to work may decide to listen to the news, weather, and nothing else during the short commute. The algorithm can account for this by assigning an extremely high value on the user's Attribute Rating segment for those particular items. Within the algorithm, vector dimensions generally have a magnitude between 0 and 1. By placing a magnitude of 100 on an attribute causes it to dominate all other factors, and ensures that the personalization algorithm chooses items in this category exclusively. The other dimensions are still counted accordingly for personalization and ordering purposes. Thus, the concept of an exclusive category can exist within the vector similarity model.

### Advertisements

In some applications, the algorithm interlaces advertisements with the content. To provide this feature, the methods and structure of the present invention may simply grant a particular category a bonus by predisposing each user towards it. The PA fulfills this goal by assigning each user to have a value of 1 (or higher) in the advertising Attribute Rating. This ensures that advertisements are presented within the model and do not swamp the regular content. Advertisements can also possess additional attributes, allowing the PA to select advertisements based on their other traits. The algorithm will target users with advertisements that they are likely to enjoy or are relevant to the user's current location.

While the invention has been illustrated and described in the drawings and foregoing description, such illustration and description is to be considered as exemplary and not restrictive in character, it being understood that only the preferred embodiment and minor variants thereof have been shown and described and that all changes and modifications that come within the spirit of the invention are desired to be protected.

What is claimed is:

1. A system for content delivery comprising:
a communication medium (104);
a client component (100) coupled to said communication medium for presenting received content to a user wherein said client component includes:
a selection component (112) for permitting a user of said client component to select received content to be presented; and
a feedback component (112) to communicate the selections to a server component; and
a server component (102) coupled to said communication medium for delivering content to said client component wherein said server component includes:
a personalization component (122) for recommending content for delivery to an identified user of said client component in response to information received from said feedback component.

2. The system of claim 1 wherein said client component further includes:
a cache memory (108) for storing said received content for later selection and presentation.

3. The system of claim 1 wherein said client component further includes:
a global positioning system (110) component to identify a present location of said client component,
wherein said selection component includes:
a location selection (112, 110) component for selecting from said received content based upon said present location of said client component.

4. The system of claim 1 wherein said client component is a Web browser and wherein said feedback component communicates with said server component via said communication medium using Hypertext Transfer Protocols (106, 116).

5. The system of claim 1 wherein said client component is operable within a portable computing device.

6. The system of claim 5 wherein said communication medium is a wireless communication medium.

7. The system of claim 1 wherein said received content comprises identification information for recommended content.

8. The system of claim 7 wherein said selection component selects recommended content based upon said identification information and requests delivery of the selected recommended content from said server component.

9. The system of claim 1 wherein said server component further includes:
a user authentication component (124) for authenticating the identity of a user of said client component.

10. The system of claim 1 wherein said personalization component includes:
a utility estimation component (226, FIGS. 6 and 7) for estimating the utility of available content wherein said utility estimation component includes utility estimation based upon said information received from said feedback component; and
a selector component (226, FIGS. 6 and 7) to select recommended content for said identified user based on the estimated utility of said available content.

11. The system of claim 10 wherein said utility estimation component includes:
a similarity graph computation component (226 FIGS. 6 and 7) for determining a similarity graph representing utility of content as a multi-dimensional vector space model.

12. The system of claim 11 wherein said selector component includes:
a similarity selector (708) that selects content based on a cosine metric of vectors in said vector space model.

13. A method operable in a server process for content selection and delivery to a client process comprising the steps of:
selecting recommended content for an identified user of said client process based upon utility information represented as a multi-dimensional similarity graph vector space model (226, FIGS. 6 and 7);
communicating said recommended content to said client process for selection by said user (226);
receiving feedback information from said client process regarding said user's selection of content from said recommended content (228, 234); and
updating said utility information based on said feedback information (230, 236).

14. The method of claim 13 wherein said utility information includes location information and wherein said feedback information includes said location information corresponding to said identified user (220).

15. The method of claim 13 further comprising the steps of:
sending the selected content to said client process in response to receipt of said feedback information (232).

16. The method of claim 13 wherein the step of selecting includes the steps of:
computing a user similarity value to identify content selected by similar user to said identified user (226, FIGS. 6 and 7); and
computing a content similarity value to identify content similar to preferences of said identified user (226, FIGS. 6 and 7).

17. The method of claim 16 wherein the step of selecting further includes the step of:
combining said user similarity value and said content similarity value to identify content to be recommended to said identified user.

18. The method of claim 13 further comprising the step of:
caching said recommended content in a memory associated with said client process for later presentation to said user of said client process.
